(19) United States
(12) Patent Application Publication
(10) Pub. No.: US 2025/0188880 A1
(43) Pub. Date: Jun. 12, 2025

(54) VENT STACK ASSEMBLIES FOR HYDROGEN DISTRIBUTION SYSTEMS AND RELATED METHODS

(71) Applicant: General Electric Company, Schenectady, NY (US)

(72) Inventor: Constantinos Minas, Slingerlands, NY (US)

(21) Appl. No.: 18/535,692

(22) Filed: Dec. 11, 2023

(51) Int. Cl. F02C 9/46; B64D 37/32; F02C 6/08; F02C 7/25; F02C 9/40

(52) U.S. Cl. CPC F02C 9/46; B64D 37/32; F02C 6/08; F02C 7/25; F02C 9/40; F05D 2220/323; F05D 2260/605; F05D 2270/09; F05D 2270/303

(57) ABSTRACT

Vent assemblies for hydrogen distribution systems and related methods are disclosed. An example apparatus to exhaust hydrogen from a hydrogen distribution system of an engine of an aircraft, the apparatus comprising a vent including a first end coupled to the hydrogen distribution system, and a second end, an exhaust tube coupled to the second end, a temperature sensor disposed adjacent to the exhaust tube, a heater coupled to the exhaust tube, and programmable circuitry to operate the heater based on an output of the temperature sensor.

### FIELD OF THE DISCLOSURE

This disclosure relates generally to hydrogen fuel distribution systems and, more particularly, to vent stack assemblies for hydrogen distribution systems and related methods.

### BACKGROUND

Aircraft fuel distribution systems support fuel storage and fuel distribution to an engine. In some examples, a fuel system can include a single, gravity feed fuel tank with an associated fuel line connecting the tank to the aircraft engine. In some examples, multiple fuel tanks can be present as part of the fuel distribution system. These tank(s) can be located in a wing, a fuselage, and/or a tail of the aircraft. The tank(s) can be connected to internal fuel pump(s) with associated valve(s) and/or plumbing to permit feeding of the engine, refueling, defueling, individual tank isolation, and/or overall optimization of an aircraft's center of gravity.

### BRIEF DESCRIPTION OF THE DRAWINGS

A full and enabling disclosure of the preferred embodiments, including the best mode thereof, directed to one of ordinary skill in the art, is set forth in the specification, which makes reference to the appended Figures, in which:

FIG. 1 is a simplified illustration of an aircraft including a hydrogen fuel distribution system and vent stack assembly in which the teachings of this disclosure can be implemented.

FIG. 2 is a simplified illustration of the vent stack assembly of FIG. 1, which is implemented in accordance with the teachings of this disclosure.

FIG. 3 is a block diagram of the fuel distribution controller circuitry of FIG. 1.

FIGS. 4-6 are flowcharts representative of example machine readable instructions and/or example operations that may be executed, instantiated, and/or performed by example programmable circuitry to implement the fuel distribution controller circuitry of FIG. 3.

FIG. 7 is a block diagram of an example processing platform including programmable circuitry structured to execute, instantiate, and/or perform the example machine readable instructions and/or perform the example operations of FIGS. 4-6 to implement the fuel distribution controller circuitry of FIG. 3.

In general, the same reference numbers will be used throughout the drawing(s) and accompanying written description to refer to the same or like parts. The figures are not necessarily to scale.

### DETAILED DESCRIPTION

During operation, hydrogen distribution systems, such as those used in fuel distribution or chemical manufacturing, can vent hydrogen intentionally and unintentionally. While intentional venting of hydrogen can be used to support systems of the hydrogen distribution system, unintentional venting can result in a large loss of hydrogen, which can be costly to replace. Example hydrogen vent assemblies disclosed herein include hydrogen concentration sensors that can be used to monitor for unintentional hydrogen venting. In some examples disclosed herein, the hydrogen concentration sensors are moveable to a distal position to prevent damage to the hydrogen concentration from fire and/or intentionally vented cryogenic hydrogen. Example hydrogen vent assemblies disclosed herein also include heaters to mitigate ice formation on the vents when the vent is exposed to cold temperatures.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Hydrogen distribution systems, such as those associated with hydrogen fuel systems, often include vents, also referred to herein as vent stacks and hydrogen exhaust systems, to vent hydrogen therefrom during operation. Hydrogen distribution systems can vent hydrogen intentionally (e.g., deliberately, etc.), such as hydrogen venting during pump startup processes, gaseous hydrogen venting from tanks, and/or tank pressurization and unintentionally, such as hydrogen venting from leaks in operational valves, the activation of a pressure relief valve on a storage tank, and/or leaks from a seal. The loss of hydrogen via vents can be difficult to detect and can be indicative of damage to a component of the hydrogen distribution system. Additionally, vents, particularly those disposed in areas regularly subjected to inclement weather, can have ice form thereon, which can inhibit flow of hydrogen therethrough. The blockage of flow through vents via ice can cause hydrogen buildup within the associated fuel distribution system, which increases the risk of fire, detonation, and component rupture.

Examples disclosed herein include vent stack assemblies that are instrumented to determine the loss rate of hydrogen from hydrogen distribution systems and that include heaters to reduce ice formation. Some examples disclosed herein include vent stack assemblies that include controller circuitry, temperature sensors, and heaters. In some such examples disclosed herein, the controller circuitry can activate the heaters when a temperature output of the temperature sensors does not satisfy a temperature threshold. In some such examples disclosed herein, the temperature threshold is between 0 degrees and 5 degrees Celsius. Some examples disclosed herein include one or more hydrogen concentration sensors disposed adjacent to an outlet of the vent stack assemblies. In some such examples disclosed herein, an output of the hydrogen concentration sensors can be used to determine a loss rate of hydrogen from a hydrogen distribution system associated with the vent stack assembly. In some examples disclosed herein, the hydrogen concentration sensor(s) can be coupled to a structural member, which can move the hydrogen concentration sensor(s) from position(s) adjacent to the outlet to position(s) distal to the outlets. In some such examples disclosed herein, the hydrogen concentration sensor(s) can be moved to the distal position(s) when a fire is detected in the vent stack assembly and/or when cryogenic hydrogen is vented from the vent stack assembly to prevent damage to the hydrogen concentration sensor(s).

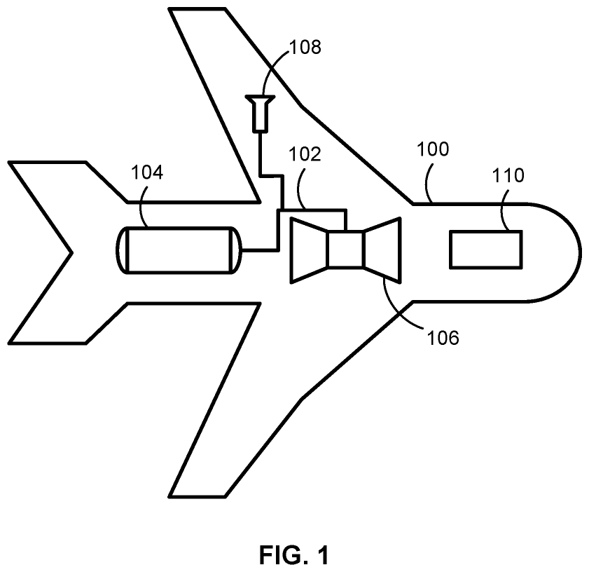

FIG. 1 is an example illustration of an aircraft 100 including an example hydrogen distribution system 102. The hydrogen distribution system 102 includes an example tank 104 of hydrogen, which provides fuel to an example gas turbine engine 106. The hydrogen distribution system 102 also includes a vent stack assembly 108 (also referred to herein as a “vent assembly”), which vents hydrogen from the hydrogen distribution system 102. The hydrogen distribution system 102 provides hydrogen fuel that will be combusted in the example gas turbine engine 106 of the aircraft 100. The tank 104 is a storage tank that can contain (e.g., store, etc.) hydrogen in various states, including liquid, gaseous, and cryo-compressed states. For example, the tank 104 can be a cryogenic hydrogen storage tank. The tank 104 can be stored in any suitable location on the aircraft (e.g., in the wings, in the fuselage, in an external tank, etc.). In other examples, the tank 104 can include multiple tanks (herein referred to as a tank bank, etc.).

The vent stack assembly 108 vents hydrogen from the hydrogen distribution system 102 and/or tank 104 into the atmosphere around the aircraft 100. The vent stack assembly 108 can be used to vent hydrogen from the tank 104 to reduce the pressure of the tank 104 and/or vent excess hydrogen from a portion of the hydrogen distribution system 102. In some examples, the vent stack assembly 108 can vent hydrogen that is unintentionally leaking from the valves and/or the other components of the hydrogen distribution system 102 (e.g., due to the small molecular size of hydrogen gas (H₂), due to seal efficacy changes from the altitude of the aircraft 100, etc.).

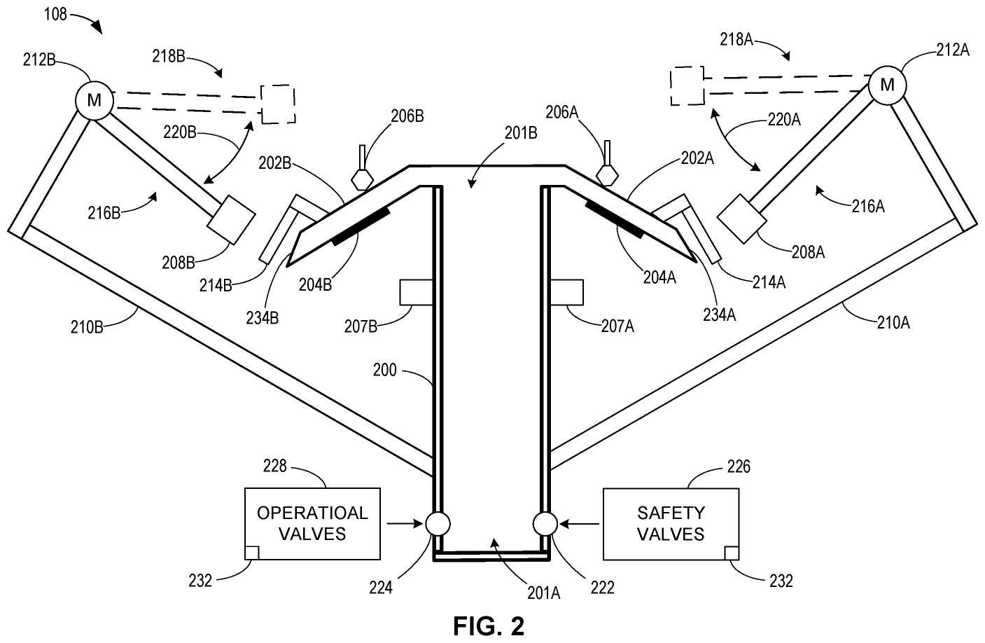

The vent stack assembly 108 can include hydrogen concentration sensors that permit vent controller circuitry 110 to determine a loss rate of hydrogen from the hydrogen distribution system 102. In some such examples, the vent stack assembly 108 can include one or more mechanical systems that enable the hydrogen concentration sensors to be moved away from the hydrogen outlets of the vent stack assembly 108 to prevent damage to the hydrogen concentration sensors from fire and/or extremely cold hydrogen. In some such examples, the vent stack assembly 108 can include fire detector sensors. The vent stack assembly 108 can include heaters to prevent the formation of ice thereon. In the illustrated example of FIG. 1, the vent stack assembly 108 is disposed on a wing of the aircraft 100. In other examples, the vent stack assembly 108 can be disposed on another location of the aircraft 100 (e.g., on the tail, on the other wing, adjacent to the tank 104, adjacent to the gas turbine engine 106, etc.). The vent stack assembly 108 is described in greater detail below in conjunction with FIG. 2.

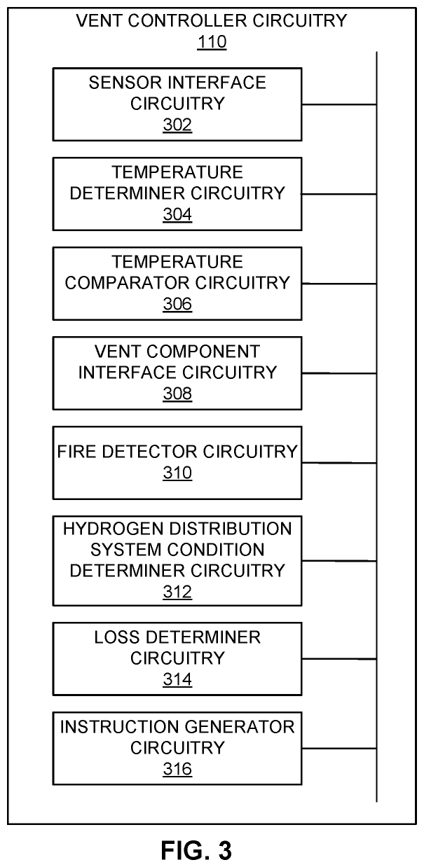

In FIG. 1, the venting of hydrogen from the hydrogen distribution system 102 is controlled and monitored by example vent controller circuitry 110. For example, the vent controller circuitry 110 can monitor the operation of the hydrogen distribution system 102 and operate the vent stack assembly 108. In some examples, the vent controller circuitry 110 operates a heater of the vent stack assembly 108 to remove ice from the vent stack assembly 108 and/or to prevent the formation of ice thereon. In some examples, the vent controller circuitry 110 can monitor the temperature of the vent stack assembly 108 and activate a heater in response to the temperature of the vent stack decreasing below a threshold temperature. In some examples, the vent controller circuitry 110 articulates (e.g., moves, etc.) one or more hydrogen concentration sensor(s) (not illustrated in FIG. 1, illustrated below in conjunction with FIG. 2) of the vent stack assembly 108 in response to detecting a fire in the vent stack assembly 108 and/or determining cryogenic hydrogen is being vented from the hydrogen distribution system 102. In some examples, the vent controller circuitry 110 determines a loss rate of hydrogen from the hydrogen distribution system 102 based on an output of one or more hydrogen concentration sensors of the vent stack assembly 108. An example implementation of the vent controller circuitry 110 is described below in conjunction with FIG. 3.

The example vent stack assemblies described herein may also be applicable to other applications where compressed hydrogen is distributed. The examples described herein also may be applicable to engine(s) other than gas turbine engines. While the gas turbine engine 106 is a power generator for the aircraft 100 that uses hydrogen as a fuel, hydrogen may also be used as a fuel for other power generators. For example, a power generator may be a fuel cell (e.g., hydrogen fuel cell, etc.) where the hydrogen is provided to the fuel cell to generate electricity by reacting with air. Additionally, the vent stack assemblies described herein can be used in conjunction with other systems where hydrogen is used as a fuel (e.g., ground-based vehicles, astronautical vehicles, consumer power generation, etc.) and/or where compressed hydrogen is utilized (e.g., as precursors in industrial chemical applications, in laboratory settings, etc.).

Although the aircraft 100 shown in FIG. 1 is an airplane, the examples described herein may also be applicable to other fixed-wing aircraft, including unmanned aerial vehicles (UAV). In the illustrated example of FIG. 1, the aircraft includes a single gas turbine engine (e.g., the gas turbine engine 106, etc.). In some examples, the aircraft 100 can include multiple gas turbine engines, such as multiple gas turbine engines mounted beneath the wings of the aircraft 100.

FIG. 2 is a schematic illustration of the vent stack assembly 108 of FIG. 1, which is implemented in accordance with the teachings of this disclosure. In the illustrated example of FIG. 2, the vent stack assembly 108 includes an example main vent 200 having an example first end 201A and an example second end 201B, an example first exhaust tube 202A, and an example second exhaust tube 202B. In the illustrated example of FIG. 2, the vent stack assembly 108 includes an example first heater 204A and an example second heater 204B that are coupled to and heat the exhaust tubes 202A, 202B, respectively. In the illustrated example of FIG. 2, the vent stack assembly 108 includes an example first temperature sensor 206A and an example second temperature sensor 206B that monitor the temperature of the exhaust tubes 202A, 202B, respectively. In the illustrated example of FIG. 2, the vent stack assembly 108 includes an example first fire detector 207A and an example second fire detector 207B. In the illustrated example of FIG. 2, the vent stack assembly 108 includes an example first hydrogen concentration sensor 208A and an example second hydrogen concentration sensor 208B, which are coupled to an example first structural member 210A and an example second structural member 210B, respectively, and moveable relative to the other components of the vent stack assembly 108 via an example first motor 212A and an example second motor 212B, respectively. In the illustrated example of FIG. 2, the vent stack assembly 108 includes an example first flame arrestor 214A and an example second flame arrestor 214B.

In the illustrated example of FIG. 2, the structural members 210A, 210B and the hydrogen concentration sensors 208A, 208B are moveable from an example first adjacent position 216A and an example second adjacent position 216B, respectively, to an example first distal position 218A and an example second distal position 218B, respectively, via an example first movement 220A and an example second movement 220B. In the illustrated example of FIG. 2, the vent stack assembly 108 includes an example first port 222 and an example second port 224, which receive vented hydrogen from examples safety valves 226 of the hydrogen distribution system 102 of FIG. 1 and example operational valve(s) 228 of the hydrogen distribution system 102 of FIG. 1, respectively.

The main vent 200, also referred to herein as a “vent stack” and a “vent”, and the exhaust tubes 202A, 202B are coupled to the ports 222, 224, and vent hydrogen from the hydrogen distribution system 102. In the illustrated example of FIG. 2, the ports 222, 224 are coupled to the first end 201A and the exhaust tubes 202A, 202B are coupled to the second end 201B. Hydrogen enters the main vent 200 from the first port 222 and the second port 224, flows through the main vent 200 from the first end 201A to the second end 201B, and into the ambient environment via the exhaust tubes 202A, 202B. The main vent 200 and exhaust tubes 202A, 202B facilitate the venting of hydrogen from the hydrogen distribution system 102 during operation thereof. In the illustrated example of FIG. 2, the main vent 200 and the exhaust tubes 202A, 202B have cylindrically shaped bodies. In the illustrated example of FIG. 2, the exhaust tubes 202A, 202B are coupled to the second end 201B (e.g., the top, etc.) of the main vent 200, in a position distal to the ports 222, 224. It should be appreciated that the teachings of this disclosure can also be used in conjunction with hydrogen vents having any other suitable shape and/or configuration.

In the illustrated example of FIG. 2, the exhaust tubes 202A, 202B include an example first outlet 234A and an example second outlet 234B, respectively. In the illustrated example of FIG. 2, the outlets 234A, 234B are angularly cut (e.g., mitered cut, etc.), and the exhaust tubes 202A, 202B slope downward relative to the main vent 200, which reduces intrusion of precipitation into the vent stack assembly 108. In other examples, such as those in which the vent stack assembly 108 is not expected to encounter precipitation, the main vent 200 and the exhaust tubes 202A, 202B can have another suitable configuration (e.g., the exhaust tubes 202A, 202B are sloped upwards, extend from the second end 201B at a right angle, etc.).

During operation, fire(s) can occur in the main vent 200 and the exhaust tubes 202A, 202B. For example, fire(s) can enter the main vent 200 and the exhaust tubes 202A, 202B from the hydrogen distribution system 102 via the ports 222, 224. Additionally or alternatively, fire can ignite within the main vent 200 and the exhaust tubes 202A, 202B (e.g., from static electricity produced via friction between the hydrogen flowing through the main vent 200 and the exhaust tubes 202A, 202B and interior surfaces thereof, high ambient heats, etc.). The main vent 200 and the exhaust tubes 202A, 202B can be composed of material that is temperature and fire-resistant (e.g., a composite, a metal, etc.). In the illustrated example of FIG. 2, the vent stack assembly 108 includes two exhaust tubes (e.g., the exhaust tubes 202A, 202B, etc.). In other examples, the vent stack assembly 108 can include a different number of exhaust tubes (e.g., one exhaust tube, three exhaust tubes, five exhaust tubes, etc.). In some such examples, the vent stack assembly 108 can include components associated with the additional exhaust tubes (e.g., corresponding heaters, temperature sensors, hydrogen sensors, structural members, and motors for each of the exhaust tubes, etc.).

During operation, cold temperatures (e.g., associated with the ambient temperature, associated with the flow of cold hydrogen, etc.) can cause ice to form on and/or in the exhaust tubes 202A, 202B. In some examples, the ice can inhibit (e.g., prevent, reduce, etc.) the flow of vented hydrogen through the vent stack assembly 108 and cause hydrogen to accumulate in the vent stack assembly 108 and/or the hydrogen distribution system 102, which can increase the risk of fire, detonation, and/or rupture of components of the hydrogen distribution system 102. The formation of ice on the exhaust tubes 202A, 202B is prevented and/or mitigated by the operation of the heaters 204A, 204B, the temperature sensors 206A, 206B, and the vent controller circuitry 110.

The heaters 204A, 204B heat (e.g., warm, increase the temperature of, etc.) the exhaust tubes 202A, 202B, respectively. In the illustrated example of FIG. 2, the heaters 204A, 204B are coupled to the exhaust tubes 202A, 202B, respectively. In other examples, the heaters 204A, 204B can be coupled to another portion of the vent stack assembly 108 (e.g., the main vent 200, etc.) and/or a component adjacent to the vent stack assembly 108 (e.g., a surface of the aircraft 100, etc.). The heaters 204A, 204B can prevent the formation of ice and/or melt ice that has formed on the exhaust tubes 202A, 202B. The heaters 204A, 204B operate based on commands (e.g., instructions, etc.) from the vent controller circuitry 110. In some examples, the heaters 204A, 204B are electric heaters. In some examples, the heaters 204A, 204B can receive power from an electric system (e.g., an accessory gearbox of the gas turbine engine 106 of FIG. 1, an electric system of the aircraft 100 of FIG. 1, a municipal power system, etc.), one or more associated batteries, and/or a same power source as the motors 212A, 212B. Additionally or alternatively, the heaters 204A, 204B can be heated via bleed air from the gas turbine engine 106 of FIG. 1 (e.g., a flow of bleed air from a compressor and/or turbine of the gas turbine engine 106, etc.). Additionally or alternatively, the heaters 204A, 204B can be chemically heated (e.g., via an exoergic reaction of chemicals stored within the heaters 204A, 204B, etc.)

The temperature sensors 206A, 206B are devices that output a digital value indicative of a temperature associated with the exhaust tubes 202A, 202B, respectively. In some examples, the temperature sensors 206A, 206B can be implemented by one or more infrared sensors, one or more thermocouples, one or more resistance temperature detectors, one or more thermistors, and/or one or more semiconductor-based sensors, one or more bimetallic sensors, one or more thermometers, etc. In some examples, the vent controller circuitry 110 (FIG. 1) can use the output(s) of the temperature sensors 206A, 206B to control the operation of the heaters 204A, 204B. In the illustrated example of FIG. 2, the temperature sensors 206A, 206B are disposed adjacent to an exterior of the exhaust tubes 202A, 202B respectively. In other examples, the temperature sensors 206A, 206B can be disposed in the interior of the exhaust tubes 202A, 202B, etc. In other examples, the temperature sensors 206A, 206B can be disposed in the main vent 200 and/or on an exterior of the main vent 200.

In the illustrated example of FIG. 2, the vent stack assembly 108 includes two temperature sensors (e.g., the temperature sensors 206A, 206B, etc.). In other examples, the vent stack assembly 108 can include any other number of temperature sensors (e.g., one temperature sensor, three temperature sensors, etc.). In some examples, the temperature sensors 206A, 206B can be absent. In some such examples, the vent controller circuitry 110 can operate the heaters based on another temperature sensor (e.g., another temperature sensor associated with the aircraft 100 of FIG. 1, another temperature sensor associated with the area housing the vent stack assembly 108, etc.) and/or a temperature reported by a weather service for the geographic area associated with the vent stack assembly 108.

The fire detectors 207A, 207B monitor the interior of the main vent 200 and/or the exhaust tubes 202A, 202B for the presence of fire. For example, the fire detectors 207A, 207B can output a signal indicative of whether there is a current fire within the vent stack assembly 108 (e.g., a first output for the presence of fire within the vent stack assembly 108, a second output for the absence of fire within the vent stack assembly 108, etc.). In some examples, the fire detectors 207A, 207B can include a multi-spectrum infrared (MIR) detector. Additionally or alternatively, the fire detectors 207A, 207B can include one or more other thermal sensors, one or more radiation sensors, and/or one or more particulate sensors. In the illustrated example of FIG. 2, the vent stack assembly 108 includes two fire detectors (e.g., the fire detectors 207A, 207B, etc.), which monitor portions of the main vent 200 downstream of the exhaust tubes 202A, 202B, respectively, for fires. In other examples, the vent stack assembly 108 can include any suitable number of fire detectors (e.g., one fire detector, three fire detectors, five fire detectors, etc.). In other examples, the fire detectors 207A, 207B are absent. In some such examples, the vent controller circuitry 110 can determine if a fire is present via the output of the temperature sensors 206A, 206B.

The hydrogen concentration sensors 208A, 208B, also referred to herein as gas sensors, are sensors that measure a concentration of hydrogen (e.g., the hydrogen concentration, etc.) in the adjacent air (e.g., the air surrounding the respective sensors, etc.). In some examples, each of the hydrogen concentration sensors 208A, 208B outputs an electrical parameter (e.g., a voltage, a current, etc.) that corresponds to a particular concentration of hydrogen around the corresponding one of the hydrogen concentration sensors 208A, 208B. In some examples, the hydrogen concentration sensors 208A, 208B can be implemented by one or more metal oxide semiconductor (MOS) sensors, one or more thermal conductivity sensor(s), one or more catalytic sensor(s), one or more electrochemical sensor(s), one or more other hydrogen sensor(s), and/or a combination thereof. In the illustrated example of FIG. 2, the hydrogen concentration sensors 208A, 208B, in the adjacent positions 216A, 216B, are positioned adjacent to the first outlet 234A of the first exhaust tube 202A and the second outlet 234B of the second exhaust tube 202B, respectively. The hydrogen concentration sensors 208A, 208B monitor the flow of hydrogen vented (e.g., exhausted, etc.) from the exhaust tubes 202A, 202B, respectively.

The structural members 210A, 210B support the hydrogen concentration sensors 208A, 208B. In the illustrated example of FIG. 2, the hydrogen concentration sensors 208A, 208B are coupled to the structural members 210A, 210B. In the illustrated example of FIG. 2, the structural members 210A, 210B extend between an exterior of the main vent 200 and the hydrogen concentration sensors 208A, 208B, respectively. In other examples, the structural members 210A, 210B can be coupled to another suitable structure (e.g., the exhaust tubes 202A, 202B, a surface of the aircraft 100 of FIG. 1, another structure, etc.). In some examples, the structural members 210A, 210B are absent. In some such examples, the hydrogen concentration sensors 208A, 208B can be coupled to the exhaust tubes 202A, 202B. In some examples, the hydrogen concentration sensors 208A, 208B can be moveably coupled to the exhaust tubes 202A, 202B, respectively, via one or more other suitable structures (e.g., a shaft, one or more gears, one or more rotary elements, etc.).

The hydrogen concentration sensors 208A, 208B can be sensitive to temperature extremes (e.g., high temperatures, low temperatures, etc.) and/or fire. For example, if exposed to temperature extremes and/or fire, the hydrogen concentration sensors 208A, 208B can become damaged, inaccurate (e.g., outputting incorrect hydrogen concentration outputs, etc.), and/or inoperable. To reduce the likelihood of such an exposure, the first hydrogen concentration sensor 208A is moveable from the first adjacent position 216A (e.g., a first position, etc.) to the first distal position 218A (e.g., a second position, etc.) and the second hydrogen concentration sensor 208B is moveable from the second adjacent position 216B (e.g., a third position, etc.) to the second distal position 218B (e.g., a fourth position, etc.). In the adjacent positions 216A, 216B, the hydrogen concentration sensors 208A, 208B are able to monitor the concentration of hydrogen in the air around the first outlet 234A and the second outlet 234B, respectively, but are susceptible to fire within the main vent 200 and exposure to extremely cold hydrogen (e.g., cryogenic hydrogen, etc.) vented from the hydrogen distribution system 102. In some such examples, the vent controller circuitry 110 can determine a loss rate of hydrogen from the hydrogen distribution system 102 based on the output(s) of the hydrogen concentration sensors 208A, 208B when the hydrogen concentration sensors 208A, 208B are in the adjacent positions 216A, 216B. In the distal positions 218A, 218B, the hydrogen concentration sensors 208A, 208B are not exposed to fire and/or extremely cold hydrogen vented via the outlets 234A, 234B, respectively, but are not able to accurately monitor the outflow of hydrogen from the outlets 234A, 234B.

The motors 212A, 212B are control elements (e.g., actuators, etc.) that actuate (e.g., move, etc.) the hydrogen concentration sensors 208A, 208B and the structural members 210A, 210B between the adjacent positions 216A, 216B, respectively, and the distal positions 218A, 218B, respectively, based on commands from the vent controller circuitry 110. In some examples, the motors 212A, 212B are electric motors (e.g., alternating current electric motors, direct current electric motors, brushless motors, magnetic-electric motors, electro-static motors, piezoelectric motors, etc.) that move the hydrogen concentration sensors 208A, 208B via electric power. In some such examples, the motors 212A, 212B can receive power from an electric system (e.g., an accessory gearbox of the gas turbine engine 106 of FIG. 1, an electric system of the aircraft of FIG. 1, a municipal power system, etc.) and/or one or more associated batteries. In other examples, the motors 212A, 212B can be powered via one or more fuels (e.g., combustion of hydrogen from the tank 104 of FIG. 1, fossil fuels, etc.). In some examples, the motors 212A, 212B are absent. In some such examples, the hydrogen concentration sensors 208A, 208B can be moved between the adjacent positions 216A, 216B to the distal positions 218A, 218B by any other suitable control element (e.g., linear actuator(s), electromagnetic actuator(s), pneumatic actuator(s), a hydraulic element(s), etc.)

In the illustrated example of FIG. 2, the motors 212A, 212B are rotary actuators that move the hydrogen concentration sensors 208A, 208B, respectively, and portion(s) of the structural members 210A, 210B, respectively, between the adjacent positions 216A, 216B, respectively, and the distal positions 218A, 218B, respectively, via the movements 220A, 220B, respectively. Additionally or alternatively, the motors 212A, 212B can include one or more linear actuator(s) that move the hydrogen concentration sensors 208A, 208B, respectively, and/or portion(s) of the structural members 210A, 210B via linear translation.

In other examples, the hydrogen concentration sensors 208A, 208B can be fixed relative to the other components of the vent stack assembly 108. In some such examples, another component (e.g., a shield, etc.) can be moveably coupled to the vent stack assembly 108. For example, in the adjacent positions 216A, 216B, the other components can protect (e.g., block, shield, etc.) the hydrogen concentration sensors 208A, 208B from cryogenic hydrogen vented via the exhaust tubes 202A, 202B, respectively, and/or a fire within the main vent 200. In some such examples, the motors 212A, 212B can move the other components between the adjacent positions 216A, 216B and the distal positions 218A, 218B.

In the illustrated example of FIG. 2, the motors 212A, 212B are disposed at a joint of the structural members 210A, 210B. In other examples, the motors 212A, 212B can be disposed at any other suitable location on the structural members 210A, 210B, and/or the vent stack assembly 108 (e.g., coupled to the exhaust tubes 202A, 202B, coupled to the main vent 200, etc.). It should be appreciated that the configuration of the hydrogen concentration sensors 208A, 208B, the structural members 210A, 210B, and the motors 212A, 212B depicted in FIG. 2 is for illustrative purposes only and is not to scale. In other examples, the hydrogen concentration sensors 208A, 208B, the structural members 210A, 210B, and the motors 212A, 212B can have other configurations that facilitate the movement of the hydrogen concentration sensors 208A, 208B between the adjacent positions 216A, 216B and the distal positions 218A, 218B.

The flame arrestors 214A, 214B (e.g., deflagration arresters, flame traps, etc.) reduce (e.g., minimize, prevent, interrupt, etc.) the flow of flames from the exhaust tubes 202A, 202B, respectively, and out of the outlets 234A, 234B. In the illustrated example of FIG. 2, the flame arrestors 214A, 214B are coupled to the outlets 234A, 234B, respectively. The flame arrestors 214A, 214B permit the flow of hydrogen through the flame arrestors 214A, 214B. The flame arrestors 214A, 214B are disposed between the outlets 234A, 234B and the hydrogen concentration sensors 208A, 208B and prevent large flames from reaching the hydrogen concentration sensors 208A, 208B in the distal positions 218A, 218B, respectively. In some examples, the flame arrestors 214A, 214B are absent.

The ports 222, 224 are openings in the main vent 200, which facilitate the inflow of the hydrogen vented from the hydrogen distribution system 102. The first port 222 and the second port 224 fluidly couple the vent stack assembly 108 to the hydrogen distribution system 102. In the illustrated example of FIG. 2, the main vent 200 includes two ports (e.g., the ports 222, 224, etc.). In other examples, the main vent 200 can include any suitable number of ports (e.g., three ports, four ports, etc.), depending on the relative position, configuration, and components of the vent stack assembly 108 and hydrogen distribution system 102.

The safety valve(s) 226 and the operational valve(s) 228 are components of the hydrogen distribution system 102 of FIG. 1 that regulate the flow of hydrogen therein via opening and closing. The safety valve(s) 226 are relief valves that operate when threshold conditions are satisfied. For example, the tank 104 (FIG. 1) can include one or more of the safety valve(s) 226, which are operable based on the pressure within the tank 104. The operational valve(s) 228 are mechanical devices that control the flow of hydrogen (e.g., gaseous hydrogen, liquid hydrogen, cryogenic hydrogen, etc.) through the hydrogen distribution system 102. For example, the operational valve(s) 228 can control the flow of hydrogen between the tank 104 and the gas turbine engine 106 (FIG. 1) and/or other components of the hydrogen distribution system 102 (e.g., heat exchanger(s), compressor(s), buffer tank(s), etc.). The safety valve(s) 226 and the operational valve(s) 228 can intentionally vent hydrogen via the vent stack assembly 108 (e.g., during the pressurization and/or depressurization of the tank 104, to regulate an amount of hydrogen in a portion of the hydrogen distribution system 102, etc.) and/or unintentionally vent hydrogen via the vent stack assembly 108 (e.g., the maximum allowable working pressure (MWAP) of the tank 104 is exceeded triggering one of the safety valve(s) 226, a leak within the hydrogen distribution system 102 through one of the operational valve(s) 228, etc.).

In the illustrated example of FIG. 2, the hydrogen distribution system 102 (FIG. 1) and/or the valve(s) 226, 228 include example valve position sensors 232 that output the position of the valve(s) 226, 228 (e.g., if ones of the valve(s) 226, 228 are open/closed, etc.). The valve position sensors 232 can be implemented by one or more mechanical position sensor(s), one or more optical sensor(s), one or more strain sensor(s), etc. In some examples, the vent controller circuitry 110 can use the hydrogen concentration sensors 208A, 208B to determine a loss rate of hydrogen from the hydrogen distribution system 102. In some such examples, the vent controller circuitry 110 can, based on an output of the valve position sensors 232, determine if the hydrogen venting is associated with a cryogenic source of hydrogen. In some such examples, the vent controller circuitry 110 can move the hydrogen concentration sensors 208A, 208B to the distal positions 218A, 218B to avoid exposure of the hydrogen concentration sensors 208A, 208B to cryogenic temperatures.

FIG. 3 is a block diagram of an example implementation of the vent controller circuitry 110 of FIG. 1 to control the operation of the vent stack assembly 108 of FIGS. 1 and 2. In the illustrated example of FIG. 3, the vent controller circuitry 110 includes example sensor interface circuitry 302, example temperature determiner circuitry 304, example temperature comparator circuitry 306, example vent component interface circuitry 308, example fire detector circuitry 310, example hydrogen distribution system condition determiner circuitry 312, example loss determiner circuitry 314, and example instruction generator circuitry 316. The vent controller circuitry 110 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the vent controller circuitry 110 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

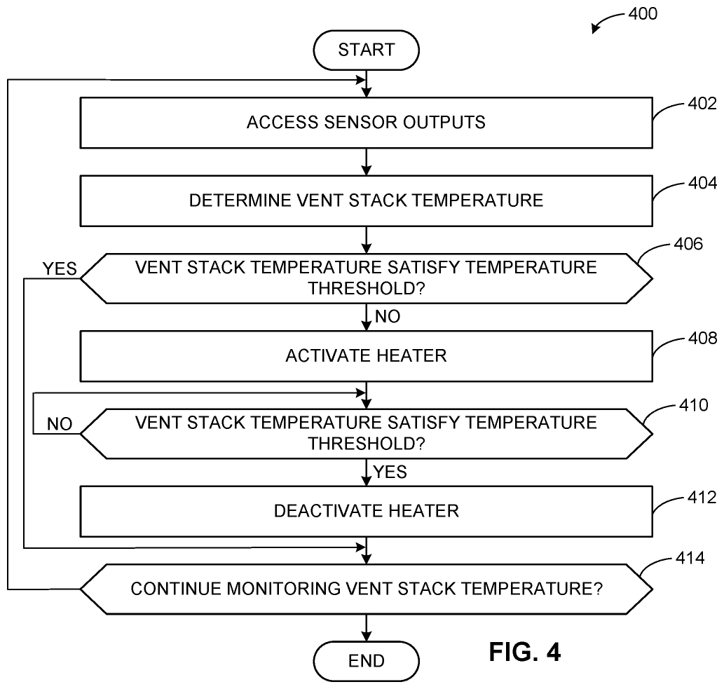

The sensor interface circuitry 302 accesses sensor data from the sensors of the vent stack assembly 108 (FIG. 1), the hydrogen distribution system 102 (FIG. 1), the aircraft 100 (FIG. 1), and/or the gas turbine engine 106 (FIG. 1). For example, the sensor interface circuitry 302 can receive sensor data from the temperature sensors 206A, 206B (FIG. 2), the fire detectors 207A, 207B (FIG. 2), the hydrogen concentration sensors 208A, 208B (FIG. 2), and/or other sensors associated with the vent stack assembly 108. Additionally or alternatively, the sensor interface circuitry 302 can interface with external sensors (e.g., other sensors associated with the aircraft 100, other sensors associated with the geographic location of the hydrogen distribution system 102, etc.) and/or a weather service to determine the ambient conditions of the vent stack assembly 108 (e.g., the ambient temperature, the ambient humidity, etc.). In some examples, the sensor interface circuitry 302 can transform the received sensor data from a machine-readable format (e.g., a voltage, a current, etc.) to a human-readable format (e.g., a string, a floating-point number, an integer, etc.). In some examples, the sensor interface circuitry 302 is instantiated by programmable circuitry executing sensor interface instructions and/or configured to perform operations such as those represented by the flowchart(s) of FIGS. 4-6.

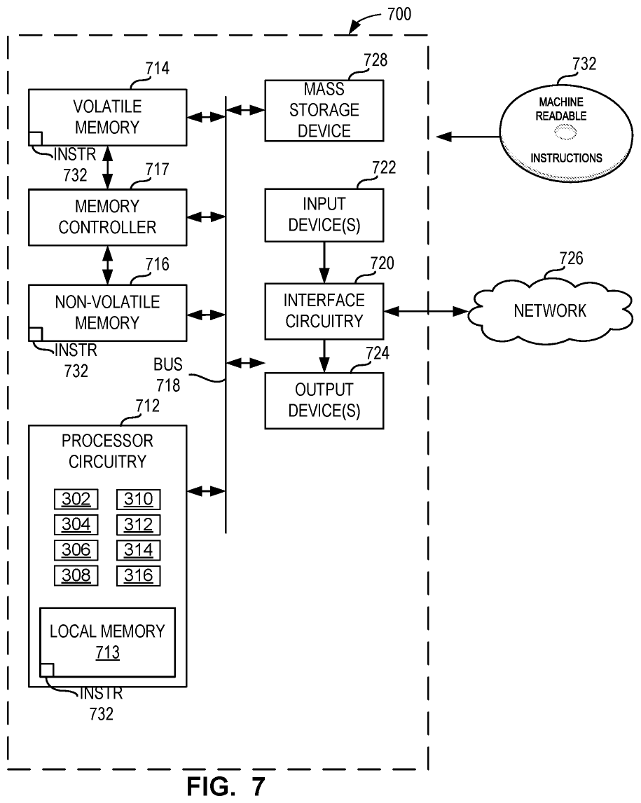

In some examples, the vent controller circuitry 110 includes means for interfacing with sensors. For example, the means for interfacing with sensors may be implemented by the sensor interface circuitry 302. In some examples, the sensor interface circuitry 302 may be instantiated by programmable circuitry such as the example programmable circuitry 712 of FIG. 7. Additionally or alternatively, the sensor interface circuitry 302 may be instantiated by any other combination of hardware, software, and/or firmware. For example, the sensor interface circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The temperature determiner circuitry 304 determines one or more temperature(s) of the vent stack assembly 108. For example, the temperature determiner circuitry 304 can determine an average temperature of the vent stack assembly 108 based on an output of the temperature sensors 206A, 206B. Additionally or alternatively, the temperature determiner circuitry 304 can determine a temperature of each of the exhaust tubes 202A, 202B based on the outputs of the temperature sensors 206A, 206B, respectively. Additionally or alternatively, the temperature determiner circuitry 304 can determine the temperature(s) of the vent stack assembly 108 based on the geographic location of the vent stack assembly 108 (e.g., a static location, a current location and altitude of the aircraft 100, etc.) and a weather service. In other examples, the temperature determiner circuitry 304 can determine the temperature of the vent stack assembly 108 based on an output of a temperature sensor disposed at a location near the vent stack assembly 108 (e.g., a temperature sensor associated with the aircraft 100, a temperature sensor associated with a facility housing the vent stack assembly 108, etc.). In some examples, the temperature determiner circuitry 304 is instantiated by programmable circuitry executing temperature determiner instructions and/or configured to perform operations such as those represented by the flowchart(s) of FIGS. 4-6.

In some examples, the vent controller circuitry 110 includes means for determining a temperature. For example, the means for determining a temperature may be implemented by the temperature determiner circuitry 304. In some examples, the temperature determiner circuitry 304 may be instantiated by programmable circuitry such as the example programmable circuitry 712 of FIG. 7. Additionally or alternatively, the temperature determiner circuitry 304 may be instantiated by any other combination of hardware, software, and/or firmware. For example, the temperature determiner circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The temperature comparator circuitry 306 compares the temperature(s) determined by the temperature determiner circuitry 304 to a temperature threshold (e.g., a threshold temperature, etc.). For example, the temperature comparator circuitry 306 can determine if the vent stack temperature satisfies the temperature threshold. In some examples, the temperature comparator circuitry 306 can determine (e.g., select, calculate, etc.) the temperature threshold based on (e.g., equal to, calculated based on a safety factor of, etc.) the freezing point of water (e.g., at sea level, at a current altitude of the vent stack assembly 108, etc.). In some examples, the temperature threshold is a temperature between 0 and 5 degrees Celsius. In some examples, multiple thresholds can be used if based on other ambient conditions of the vent stack assembly 108. For example, a higher temperature threshold (e.g., a more conservative temperature threshold, etc.) can be used if the vent stack assembly 108 is currently subject to precipitation and/or the ambient atmosphere has a high humidity. In some examples, the temperature comparator circuitry 306 is instantiated by programmable circuitry executing temperature comparator instructions and/or configured to perform operations such as those represented by the flowchart(s) of FIGS. 4-6.

In some examples, the vent controller circuitry 110 includes means for comparing a temperature to a threshold. For example, the means for comparing a temperature to a threshold may be implemented by the temperature comparator circuitry 306. In some examples, the temperature comparator circuitry 306 may be instantiated by programmable circuitry such as the example programmable circuitry 712 of FIG. 7. Additionally or alternatively, the temperature comparator circuitry 306 may be instantiated by any other combination of hardware, software, and/or firmware. For example, the temperature comparator circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The vent component interface circuitry 308 interfaces with the controllable elements of the vent stack assembly 108. For example, the vent component interface circuitry 308 can activate and deactivate the heaters 204A, 204B (FIG. 2). Additionally or alternatively, the vent component interface circuitry 308 actuates the hydrogen concentration sensors 208A, 208B and structural members 210A, 210B (FIG. 2) between the adjacent positions 216A, 216B (FIG. 2), respectively, and the distal positions 218A, 218B (FIG. 2), respectively, via the motors 212A, 212B (FIG. 2), respectively. In some examples, the vent component interface circuitry 308 can control the heaters 204A, 204B, and/or motors 212A, 212B via wired electrical signals, wireless electrical signals, hydraulic signals, pneumatic signals, and/or a direct mechanical connection. In some examples, the vent component interface circuitry 308 can control the heaters 204A, 204B based on the comparison of the temperature and the temperature threshold by the temperature comparator circuitry 306 (e.g., turn on the heater if the temperature is lower than the temperature threshold, etc.).

In some examples, the vent component interface circuitry 308 can determine a current position of the hydrogen concentration sensors 208A, 208B. For example, the vent component interface circuitry 308 can determine the position of the hydrogen concentration sensors 208A, 208B based on feedback from the motors 212A, 212B. Additionally or alternatively, the vent component interface circuitry 308 determines the position of the hydrogen concentration sensors 208A, 208B based on an output of the hydrogen concentration sensors 208A, 208B (e.g., if the hydrogen concentration sensors 208A, 208B are outputting a reading indicative of ambient atmospheric conditions, etc.). Additionally or alternatively, the vent component interface circuitry 308 determines the position of the hydrogen concentration sensors 208A, 208B based on a log of previous operations of the vent component interface circuitry 308. In some examples, the vent component interface circuitry 308 is instantiated by programmable circuitry executing vent component interface instructions and/or configured to perform operations such as those represented by the flowchart(s) of FIGS. 4-6.

In some examples, the vent controller circuitry 110 includes means for interfacing with vent stack assembly components. For example, the means for interfacing with vent stack assembly components may be implemented by the vent component interface circuitry 308. In some examples, the vent component interface circuitry 308 may be instantiated by programmable circuitry such as the example programmable circuitry 712 of FIG. 7. Additionally or alternatively, the vent component interface circuitry 308 may be instantiated by any other combination of hardware, software, and/or firmware. For example, the vent component interface circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The fire detector circuitry 310 determines if a fire is detected in the vent stack assembly 108. For example, the fire detector circuitry 310 can interface with the fire detectors 207A, 207B to determine if a fire is present in the vent stack assembly 108. In some examples, the fire detector circuitry 310 can determine if a fire is present based on an output of the temperature sensors 206A, 206B. For example, the fire detector circuitry 310 can determine whether a fire is presented based on a rapid increase in temperature detected by the temperature sensors 206A, 206B and/or extremely high temperature detected by the temperature sensors 206A, 206B. In some examples, the fire detector circuitry 310 is instantiated by programmable circuitry executing fire detector instructions and/or configured to perform operations such as those represented by the flowchart(s) of FIGS. 4-6.

In some examples, the vent controller circuitry 110 includes means for detecting a fire. For example, the means for detecting a fire may be implemented by the fire detector circuitry 310. In some examples, the fire detector circuitry 310 may be instantiated by programmable circuitry such as the example programmable circuitry 712 of FIG. 7. Additionally or alternatively, the fire detector circuitry 310 may be instantiated by any other combination of hardware, software, and/or firmware. For example, the fire detector circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The hydrogen distribution system condition determiner circuitry 312 determines a condition of the hydrogen distribution system 102. For example, the hydrogen distribution system condition determiner circuitry 312 can determine which of the safety valve(s) 226 (FIG. 2) and the operational valve(s) 228 (FIG. 2) are open and venting hydrogen through the vent stack assembly 108 based on the valve position sensors 232 (FIG. 2). Additionally or alternatively, the hydrogen distribution system condition determiner circuitry 312 can determine the vent condition of the hydrogen distribution system 102 based on a command from an operator of the hydrogen distribution system 102 (e.g., a command to undergo an operation associated with the venting of hydrogen, a command to vent hydrogen, etc.). In some examples, the hydrogen distribution system condition determiner circuitry 312 can determine if cryogenic hydrogen is being vented from the hydrogen distribution system 102 based on which of the safety valve(s) 226 and the operational valve(s) 228 are currently venting hydrogen. In some such examples, the hydrogen distribution system condition determiner circuitry 312 can interface with a memory structure (e.g., a database, etc.) that includes a data structure indicating which of the safety valve(s) 226 and the operational valve(s) 228 are associated with cryogenic hydrogen. In some examples, the hydrogen distribution system condition determiner circuitry 312 is instantiated by programmable circuitry executing hydrogen distribution system condition determiner instructions and/or configured to perform operations such as those represented by the flowchart(s) of FIGS. 4-6.

In some examples, the vent controller circuitry 110 includes means for determining a condition of a hydrogen distribution system. For example, the means for determining a condition of a hydrogen distribution system may be implemented by the hydrogen distribution system condition determiner circuitry 312. In some examples, the hydrogen distribution system condition determiner circuitry 312 may be instantiated by programmable circuitry such as the example programmable circuitry 712 of FIG. 7. Additionally or alternatively, the hydrogen distribution system condition determiner circuitry 312 may be instantiated by any other combination of hardware, software, and/or firmware. For example, the hydrogen distribution system condition determiner circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The loss determiner circuitry 314 determines a loss rate of hydrogen from the hydrogen distribution system 102. For example, the loss determiner circuitry 314 can determine the flow rate of hydrogen from the hydrogen distribution system 102 based on the outputs of the hydrogen concentration sensors 208A, 208B. In some examples, the loss determiner circuitry 314 determines the loss rate of hydrogen (e.g., the unintentional loss rate of hydrogen, etc.) of the hydrogen distribution system 102 via a look-up table and/or a regression model (e.g., a linear regression, a polynomial regression, etc.).

In some such examples, the look-up table used by the loss determiner circuitry 314 can be generated empirically (e.g., experimentally correlating readings from the hydrogen concentration sensors 208A, 208B and a flowmeter, etc.), analytically (e.g., via fluid mechanics, via the geometry of the vent stack assembly 108, etc.), and/or via flow modeling. Additionally or alternatively, the loss determiner circuitry 314 can determine the flow rate of hydrogen analytically (e.g., via mathematics, flow principles, etc.) and/or via modeling. In some examples, the loss determiner circuitry 314 is instantiated by programmable circuitry executing loss determiner instructions and/or configured to perform operations such as those represented by the flowchart(s) of FIGS. 4-6.

In some examples, the vent controller circuitry 110 includes means for determining a loss rate of hydrogen. For example, the means for determining a loss rate of hydrogen may be implemented by the loss determiner circuitry 314. In some examples, the loss determiner circuitry 314 may be instantiated by programmable circuitry such as the example programmable circuitry 712 of FIG. 7. Additionally or alternatively, the loss determiner circuitry 314 may be instantiated by any other combination of hardware, software, and/or firmware. For example, the loss determiner circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The instruction generator circuitry 316 generates instruction(s) related to the hydrogen distribution system 102. For example, the instruction generator circuitry 316 can generate an instruction to service the hydrogen distribution system 102 if the loss determiner circuitry 314 determines the loss rate of hydrogen from the hydrogen distribution system 102 satisfies a loss rate. For example, the instruction generator circuitry 316 can generate an instruction to repair and/or service one or more of the safety valve(s) 226, the operational valve(s) 228, and/or the tank 104 (FIG. 1). In some examples, the instruction generator circuitry 316 can generate a visual alert, an audio alert, and/or a haptic alert to a user of the hydrogen distribution system 102 and/or the aircraft 100. In some examples, the instruction generator circuitry 316 can generate a data structure that can be reviewed the next time the hydrogen distribution system 102 and/or the aircraft is to be serviced. In some examples, the instruction generator circuitry 316 is instantiated by programmable circuitry executing instruction generator instructions and/or configured to perform operations such as those represented by the flowchart(s) of FIGS. 4-6.

In some examples, the vent controller circuitry 110 includes means for generating an instruction. For example, the means for generating an instruction may be implemented by the instruction generator circuitry 316. In some examples, the instruction generator circuitry 316 may be instantiated by programmable circuitry such as the example programmable circuitry 712 of FIG. 7. Additionally or alternatively, the instruction generator circuitry 316 may be instantiated by any other combination of hardware, software, and/or firmware. For example, the instruction generator circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the vent controller circuitry 110 of FIG. 1 is illustrated in FIG. 3, one or more of the elements, processes, and/or devices illustrated in FIG. 3 may be combined, divided, re-arranged, omitted, eliminated, and/or implemented in any other way. Further, the example sensor interface circuitry 302, the example temperature determiner circuitry 304, the temperature comparator circuitry 306, the vent component interface circuitry 308, the fire detector circuitry 310, the hydrogen distribution system condition determiner circuitry 312, the loss determiner circuitry 314, the instruction generator circuitry 316, and/or, more generally, the example vent controller circuitry 110 of FIG. 3, may be implemented by hardware alone or by hardware in combination with software and/or firmware. Thus, for example, any of the example sensor interface circuitry 302, the example temperature determiner circuitry 304, the temperature comparator circuitry 306, the vent component interface circuitry 308, the fire detector circuitry 310, the hydrogen distribution system condition determiner circuitry 312, the loss determiner circuitry 314, the instruction generator circuitry 316, and/or, more generally, the example vent controller circuitry 110, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example vent controller circuitry 110 of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the vent controller circuitry 110 of FIG. 3 and/or representative of example operations which may be performed by programmable circuitry to implement and/or instantiate the vent controller circuitry 110 of FIG. 3, are shown in FIGS. 4-6. The machine readable instructions may be one or more executable programs or portion(s) of one or more executable programs for execution by programmable circuitry such as the programmable circuitry 712 shown in the example programmable circuitry platform 700 discussed below in connection with FIG. 7 and/or may be one or more function(s) or portion(s) of functions to be performed by other programmable circuitry (e.g., an FPGA). In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4-6, many other methods of implementing the example vent controller circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-6 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to operate the heaters 204A, 204B and mitigate/prevent ice formation on the vent stack assembly 108 of FIG. 2. The example machine-readable instructions and/or the example operations 400 of FIG. 4 begin at block 402, at which the sensor interface circuitry 302 (FIG. 3) accesses sensor outputs. For example, the sensor interface circuitry 302 can access sensor outputs from the temperature sensors 206A, 206B of FIG. 2. Additionally or alternatively, the sensor interface circuitry 302 can access sensor data from other sensors of the vent stack assembly 108, the hydrogen distribution system 102 (FIG. 1), and/or the aircraft 100 (FIG. 1) (e.g., a location of the aircraft, an altitude of the aircraft, etc.). In other examples, the sensor interface circuitry 302 can access information relating to the ambient atmospheric conditions for a weather service.

At block 404, the temperature determiner circuitry 304 (FIG. 3) determines the vent stack temperature. For example, the temperature determiner circuitry 304 can determine an average temperature of the vent stack assembly 108 based on an output of the temperature sensors 206A, 206B. Additionally or alternatively, the temperature determiner circuitry 304 can determine the vent stack temperature based on the geographic location of the vent stack assembly 108 (e.g., a static location, a current location, and altitude of the aircraft 100, etc.) and a weather service. In other examples, the temperature determiner circuitry 304 can determine the temperature of the vent stack based on an output of a temperature sensor disposed at a location near the vent stack assembly 108 (e.g., a temperature sensor associated with the aircraft 100, a temperature sensor associated with a facility housing the vent stack assembly 108, etc.).

At block 406, the temperature comparator circuitry 306 (FIG. 3) determines if the vent stack temperature satisfies a temperature threshold. For example, the temperature comparator circuitry 306 can compare the temperature(s) determined by the temperature determiner circuitry 304 during the execution of block 404. In some examples, the temperature threshold can be based on (e.g., equal to, calculated based on a safety factor of, etc.) the freezing point of water (e.g., at sea level, at a current altitude of the vent stack assembly 108, etc.). For example, the temperature threshold can be a value between 0 and 5 degrees Celsius. In some examples, multiple thresholds can be used if based on other ambient conditions of the vent stack assembly 108. For example, a higher temperature threshold (e.g., a more conservative temperature threshold, etc.) can be used if the vent stack assembly 108 is currently subject to precipitation and/or the ambient atmosphere has a high humidity. If the temperature comparator circuitry 306 determines the temperature satisfies the temperature threshold (e.g., the temperature is greater than the threshold temperature, etc.), the operations 400 advance to block 414. If the temperature comparator circuitry 306 determines that the temperature does not satisfy the temperature threshold (e.g., the temperature is less than the threshold temperature, etc.), then the operations 400 advance to block 414.

At block 408, the vent component interface circuitry 308 (FIG. 3) activates the heaters 204A, 204B. For example, the vent component interface circuitry 308 can cause the heaters 204A, 204B to begin outputting heat to warm the exhaust tubes 202A, 202B (FIG. 2) to prevent the formation thereon. At block 410, the temperature comparator circuitry 306 determines if the vent stack temperature satisfies the temperature threshold. For example, the temperature comparator circuitry 306 can compare a current temperature of the exhaust tubes 202A, 202B (e.g., as accessed from the temperature sensors 206A, 206B, determined by the temperature determiner circuitry 304, etc.) to the temperature threshold. If the temperature comparator circuitry 306 determines the temperature satisfies the temperature threshold (e.g., the temperature is greater than the threshold temperature, etc.), then the operations 400 advance to block 412. If the temperature comparator circuitry 306 determines the temperature does not satisfy the temperature threshold (e.g., the temperature is less than the threshold temperature, etc.), then the operations 400 repeat the execution of block 410 (e.g., the heaters 204A, 204B remain activated until the temperature of the exhaust tubes 202A, 202B increase above the threshold temperature, etc.).

At block 412, the vent component interface circuitry 308 (FIG. 3) deactivates the heaters 204A, 204B. For example, the vent component interface circuitry 308 can cause the heaters 204A, 204B to cease warming the exhaust tubes 202A, 202B to prevent the formation thereon.

At block 414, the temperature determiner circuitry 304 and/or the vent component interface circuitry 308 determines if monitoring of the temperature of the vent stack assembly 108 is to continue. For example, the temperature determiner circuitry 304 and/or the vent component interface circuitry 308 can determine to continue monitoring the temperature of the vent stack assembly 108 if the hydrogen distribution system 102 and/or the aircraft 100 is operating. In some examples, the temperature determiner circuitry 304 and/or the vent component interface circuitry 308 can determine to cease monitoring the temperature of the vent stack assembly 108 if the aircraft 100 enters at geographic area that is extremely warm (e.g., a tropic climate, a desert climate, etc.). If the temperature determiner circuitry 304 and/or the vent component interface circuitry 308 determine the monitoring is to continue, then the operations 400 return to block 402. If the temperature determiner circuitry 304 and/or the vent component interface circuitry 308 determine the monitoring is not to continue, then the operations 400 end.

The example operations 400 are described with respect to an average temperature of the vent stack assembly 108 (e.g., an average temperature is determined at block 404, the average temperature is compared to a threshold at block 406, and both of the heaters 204A, 204B are activated at block 408, etc.). In other examples, the temperature of the exhaust tubes 202A, 202B can be considered independently and used to independently operate the heaters 204A, 204B. It should be appreciated that vent stack assemblies similar to the vent stack assembly 108 of FIGS. 1 and 2, which include additional exhaust tubes, heaters, and/or temperature sensors, can be similarly operated.

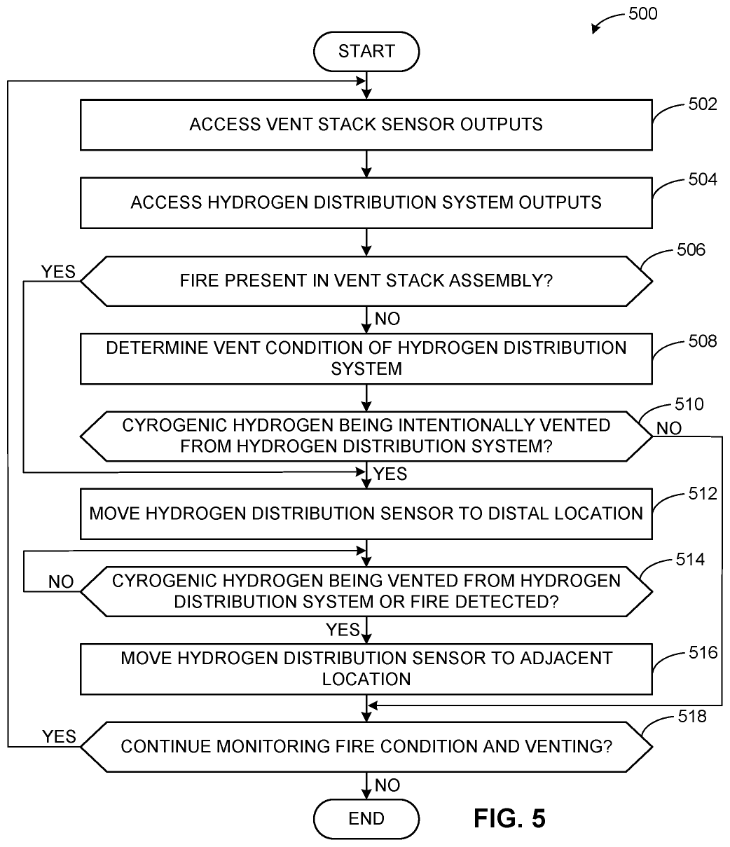

FIG. 5 is a flowchart representative of example machine readable instructions and/or example operations 500 that may be executed, instantiated, and/or performed by programmable circuitry to articulate the hydrogen concentration sensors 208A, 208B (FIG. 2) between the adjacent positions 216A, 216B (FIG. 2), respectively, to the distal positions 218A, 218B (FIG. 2), respectively. The example machine-readable instructions and/or the example operations 500 of FIG. 5 begin at block 502, at which the sensor interface circuitry 302 (FIG. 3) accesses vent stack sensor outputs. For example, the sensor interface circuitry 302 can access sensor outputs from the temperature sensors 206A, 206B of FIG. 2 and/or the fire detectors 207A, 207B (FIG. 2). At block 504, the sensor interface circuitry 302 accesses outputs for the hydrogen distribution system 102 (FIG. 1). For example, the sensor interface circuitry 302 can access sensor data from the valve position sensors 232 (FIG. 2) to determine which of the safety valve(s) 226 (FIG. 2) and the operational valve(s) 228 (FIG. 2) are open and venting hydrogen to the vent stack assembly 108 (FIG. 2).

At block 506, the fire detector circuitry 310 (FIG. 3) determines whether a fire is detected in the vent stack assembly 108. For example, the fire detector circuitry 310 can interface with the fire detectors 207A, 207B to determine if a fire is present in the vent stack assembly 108. In some examples, the fire detector circuitry 310 can determine if a fire is present based on an output of the temperature sensors 206A, 206B. For example, the fire detector circuitry 310 can determine whether a fire is presented based on a rapid increase in temperature detected by the temperature sensors 206A, 206B and/or extremely high temperature detected by the temperature sensors 206A, 206B. If the fire detector circuitry 310 determines a fire is present in the vent stack assembly 108, then the operations 500 advance to block 512. If the fire detector circuitry 310 determines a fire is not present in the vent stack assembly 108, then the operations 500 advance to block 508.

At block 508, the hydrogen distribution system condition determiner circuitry 312 (FIG. 3) determines the vent condition of the hydrogen distribution system 102. For example, the hydrogen distribution system condition determiner circuitry 312 can determine which of the safety valve(s) 226 and the operational valve(s) 228 are open and venting hydrogen through the vent stack assembly 108 based on the valve position sensors 232. Additionally or alternatively, the hydrogen distribution system condition determiner circuitry 312 can determine the vent condition of the hydrogen distribution system 102 (FIG. 1) based on a command from an operator of the hydrogen distribution system 102 (e.g., a command to undergo an operation associated with the venting of hydrogen, a command to vent hydrogen, etc.).

At block 510, the hydrogen distribution system condition determiner circuitry 312 determines if cryogenic hydrogen is being vented via the vent stack assembly 108. For example, the hydrogen distribution system condition determiner circuitry 312 can determine if one of the currently venting safety valve(s) 226 and the operational valve(s) 228 is associated with cryogenic hydrogen (e.g., one of the safety valve(s) 226 installed on a cryogenic hydrogen tank, one of the operational valve(s) 228 through which cryogenic hydrogen flows, etc.). If the hydrogen distribution system condition determiner circuitry 312 determines cryogenic hydrogen is being vented via the vent stack assembly 108, then the operations 500 advance to block 512. If the hydrogen distribution system condition determiner circuitry 312 determines cryogenic hydrogen is not being vented via the vent stack assembly 108, then the operations 500 advance to block 518.

At block 512, the vent component interface circuitry 308 (FIG. 3) moves the hydrogen concentration sensors 208A, 208B to the distal positions 218A, 218B, respectively. For example, the vent component interface circuitry 308 can cause the motors 212A, 212B (FIG. 2), respectively to rotate the structural members 210A, 210B (FIG. 2) via the movements 220A, 220B (FIG. 2), respectively. In some such examples, the movement of the hydrogen concentration sensors 208A, 208B reduces (e.g., prevents, etc.) damage to the hydrogen concentration sensors 208A, 208B from the fire in the vent stack assembly 108 and/or the venting cryogenic hydrogen.

At block 514, the hydrogen distribution system condition determiner circuitry 312 and the fire detector circuitry 310 determine if cryogenic hydrogen is being vented from the hydrogen distribution system 102 or if a fire is detected in the vent stack assembly 108, respectively. For example, the hydrogen distribution system condition determiner circuitry 312 can determine if cryogenic hydrogen is being vented and/or ceased being vented in a similar manner as the execution of block 510. For example, the fire detector circuitry 310 can determine if a fire is presented and/or absent in the vent stack assembly 108 in a similar manner as the execution of block 506. If the hydrogen distribution system condition determiner circuitry 312 and the fire detector circuitry 310 determine cryogenic hydrogen system has ceased being vented from the hydrogen distribution system 102 and if fire is not detected in the vent stack assembly 108, then the operations 500 advances to block 516. If the hydrogen distribution system condition determiner circuitry 312 and the fire detector circuitry 310 determine cryogenic hydrogen system is being vented from the hydrogen distribution system 102 and fire in the vent stack assembly 108, then the operations 500 repeat execution of block 514 (e.g., the hydrogen concentration sensors 208A, 208B remain in the distal positions 218A, 218B until cryogenic hydrogen stops being vented or the fire within the vent stack assembly 108, is extinguished, etc.).

At block 516, the vent component interface circuitry 308 moves the hydrogen concentration sensors 208A, 208B to the adjacent positions 216A, 216B, respectively. For example, the vent component interface circuitry 308 can cause the motors 212A, 212B, respectively, to rotate the structural members 210A, 210B via the movements 220A, 220B, respectively. In some such examples, the movement of the hydrogen concentration sensors 208A, 208B back to the adjacent positions 216A, 216B enables the vent controller circuitry to use output(s) of the hydrogen concentration sensors 208A, 208B to determine a loss rate of hydrogen from the hydrogen distribution system 102.

At block 518, the hydrogen distribution system condition determiner circuitry 312 and/or the fire detector circuitry 310 determine if monitoring for cryogenic venting and/or fire of the vent stack assembly 108 is to continue. For example, the hydrogen distribution system condition determiner circuitry 312 and/or the fire detector circuitry 310 can determine to continue monitoring the condition of the vent stack assembly 108 if the hydrogen distribution system 102 and/or the aircraft 100 is operating. If the hydrogen distribution system condition determiner circuitry 312 and/or the fire detector circuitry 310 determine that the monitoring is to continue, then the operations 500 return to block 502. If the hydrogen distribution system condition determiner circuitry 312 and/or the fire detector circuitry 310 determine that the monitoring is not to continue, then the operations 500 end.

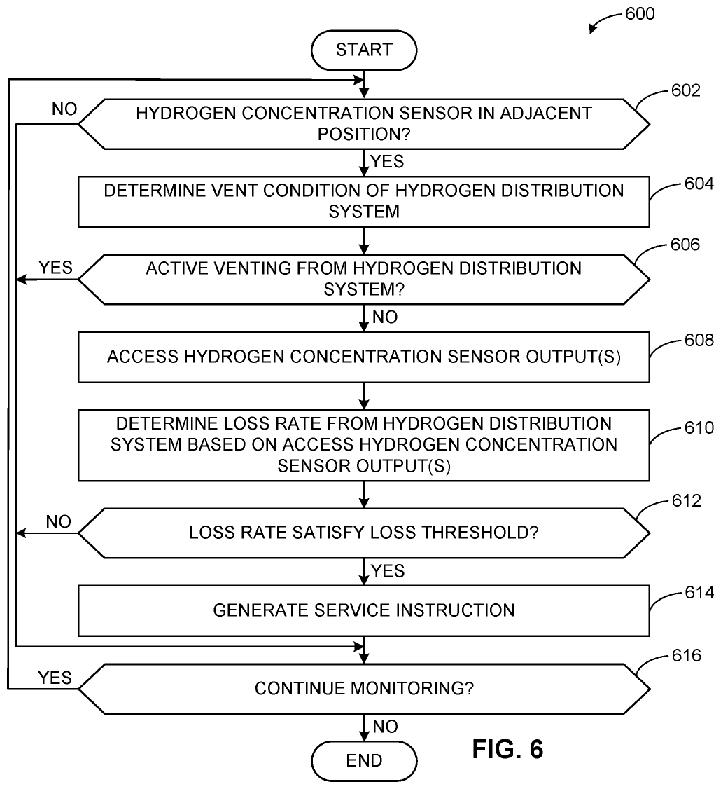

FIG. 6 is a flowchart representative of example machine readable instructions and/or example operations 600 that may be executed, instantiated, and/or performed by programmable circuitry to determine a loss rate of hydrogen from the hydrogen distribution system 102 of FIG. 1. The example machine-readable instructions and/or the example operations 600 of FIG. 6 begin at block 602, at which the vent component interface circuitry 308 (FIG. 3) determines if the hydrogen concentration sensors 208A, 208B (FIG. 2) are in the adjacent positions 216A, 216B (FIG. 2), respectively. For example, the vent component interface circuitry 308 can determine the position of the hydrogen concentration sensors 208A, 208B based on feedback from the motors 212A, 212B (FIG. 2). Additionally or alternatively, the vent component interface circuitry 308 determines the position of the hydrogen concentration sensors 208A, 208B can determine a position of the hydrogen concentration sensors 208A, 208B based on an output of the hydrogen concentration sensors 208A, 208B (e.g., if the hydrogen concentration sensors 208A, 208B are outputting a reading indicative of ambient atmospheric conditions, etc.). Additionally or alternatively, the vent component interface circuitry 308 determines the position of the hydrogen concentration sensors 208A, 208B based on a log of previous operations (e.g., previous executions of the operations 500, etc.). If the vent component interface circuitry 308 determines that the hydrogen concentration sensors 208A, 208B are in the adjacent positions 216A, 216B, then the operations 600 advance to block 604. If the vent component interface circuitry 308 determines that the hydrogen concentration sensors 208A, 208B are not in the adjacent positions 216A, 216B (e.g., the hydrogen concentration sensors 208A, 208B are in the distal positions 218A, 218B (FIG. 2), etc.), then the operations 600 advance to block 616.

At block 604, the hydrogen distribution system condition determiner circuitry 312 (FIG. 3) determines the vent condition of the hydrogen distribution system 102. For example, the hydrogen distribution system condition determiner circuitry 312 can determine which of the safety valve(s) 226 (FIG. 2) and the operational valve(s) 228 (FIG. 2) are open and venting hydrogen through the vent stack assembly 108 based on the valve position sensors 232 (FIG. 2). Additionally or alternatively, the hydrogen distribution system condition determiner circuitry 312 can determine the vent condition of the hydrogen distribution system 102 based on a command from an operator of the hydrogen distribution system 102 (e.g., a command to undergo an operation associated with the venting of hydrogen, a command to vent hydrogen, etc.).

At block 606, the hydrogen distribution system condition determiner circuitry 312 determines whether hydrogen is being intentionally vented from the hydrogen distribution system 102. For example, the hydrogen distribution system condition determiner circuitry 312 can determine if one of the operational valve(s) 228 has been opened (e.g., during a startup process of a pump, during a startup process of a compressor, etc.) and/or if one of the safety valve(s) 228 has been opened intentionally (e.g., during a transient operation of the tank 104, etc.). If the hydrogen distribution system condition determiner circuitry 312 determines that hydrogen is being intentionally vented from the hydrogen distribution system 102, then the operations 600 advance to block 616. If the hydrogen distribution system condition determiner circuitry 312 determines that hydrogen is not being intentionally vented from the hydrogen distribution system 102, then the operations 600 advance to block 608.

At block 608, the sensor interface circuitry 302 (FIG. 2) accesses the outputs of the hydrogen concentration sensors 208A, 208B. For example, the sensor interface circuitry 302 can access outputs that correspond to a concentration of hydrogen adjacent to the hydrogen concentration sensors 208A, 208B and the outlets 234A, 234B (FIG. 2) (e.g., the flow leaving the vent stack assembly 108, etc.).

At block 610, the loss determiner circuitry 314 (FIG. 3) determines a loss rate of hydrogen from the hydrogen distribution system 102. For example, the loss determiner circuitry 314 can determine the flow rate of hydrogen from the hydrogen distribution system 102 based on the outputs of the hydrogen concentration sensors 208A, 208B. In some examples, the loss determiner circuitry 314 determines the loss rate of hydrogen (e.g., the unintentional loss rate of hydrogen, etc.) of the hydrogen distribution system 102 via a look-up table and/or a regression model (e.g., a linear regression, a polynomial regression, etc.). In some such examples, the lookup table used by the loss determiner circuitry 314 can be generated empirically (e.g., experimentally correlating readings from the hydrogen concentration sensors 208A, 208B and a flowmeter, etc.), analytically (e.g., via fluid mechanics, via the geometry of the vent stack assembly 108, etc.), and/or via flow modeling. Additionally or alternatively, the loss determiner circuitry 314 can determine the flow rate of hydrogen analytically (e.g., via mathematics, flow principles, etc.) and/or via modeling.

At block 612, the loss determiner circuitry 314 determines if the loss rate of hydrogen from the hydrogen distribution system 102 satisfies a loss threshold. For example, the loss determiner circuitry 314 can compare the loss rate determined during the execution of block 610 to a loss threshold. In some examples, the loss threshold used by the loss determiner circuitry 314 can be based on a capacity of the tank 104 (FIG. 1) and/or a configuration of the hydrogen distribution system 102. In some examples, the loss threshold used by the loss determiner circuitry 314 can be set by an operator of the hydrogen distribution system 102. In some examples, the loss threshold can be an absolute value (e.g., 1 kilogram of hydrogen an hour, etc.) and/or a relative value (e.g., 0.001% of the capacity of the hydrogen tank in an hour, etc.). If the loss determiner circuitry 314 determines that the loss rate satisfies the loss threshold, then the operations 600 advance to block 614. If the loss determiner circuitry 314 determines that the loss rate does not satisfy the loss threshold, then the operations 600 advance to block 616.

At block 614, the instruction generator circuitry 316 (FIG. 3) generates an instruction to service the hydrogen distribution system 102. For example, the instruction generator circuitry 316 can generate a service instruction to repair and/or service one or more of the safety valve(s) 226, the operational valve(s) 228, and/or the tank 104. In some examples, the instruction generator circuitry 316 can generate a visual alert, an audio alert, and/or a haptic alert to a user of the hydrogen distribution system 102 and/or the aircraft 100 (FIG. 1). In some examples, the instruction generator circuitry 316 can generate a data structure that can be reviewed the next time the hydrogen distribution system 102 and/or the aircraft is to be serviced.

At block 616, the loss determiner circuitry 314 determines whether hydrogen loss monitoring is to continue. For example, the loss determiner circuitry 314 can determine to continue monitoring the loss rate of hydrogen from the hydrogen distribution system 102 if the hydrogen distribution system 102 and/or the aircraft 100 is operating. If the loss determiner circuitry 314 determines that the monitoring is to continue, then the operations 600 return to block 602. If the loss determiner circuitry 314 determines that the monitoring is not to continue, then the operations 600 end.

FIG. 7 is a block diagram of an example programmable circuitry platform 700 structured to execute and/or instantiate the example machine-readable instructions and/or the example operations of FIGS. 4-6 to implement the vent controller circuitry 110 of FIG. 3. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example sensor interface circuitry 302, the example temperature determiner circuitry 304, the temperature comparator circuitry 306, the vent component interface circuitry 308, the fire detector circuitry 310, the hydrogen distribution system condition determiner circuitry 312, the loss determiner circuitry 314, and the instruction generator circuitry 316 of FIG. 3.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 4-6, may be stored in the mass storage device 728, in the volatile memory 714, in the non-volatile memory 716, and/or on at least one non-transitory computer readable storage medium such as a CD or DVD which may be removable.

From the foregoing, it will be appreciated that example systems, apparatus, articles of manufacture, and methods have been disclosed for hydrogen vents that include hydrogen distribution sensor. Example hydrogen vent assemblies disclosed herein facilitate the detection of leaks and/or malfunctioning components within a hydrogen distribution system by detecting unintentionally vented hydrogen flowing therefrom. Example hydrogen vent assemblies include heaters to prevent the formation of ice on the hydrogen distribution vents, which prevents the formation of ice thereon. Such vents can be applicable in situations where hydrogen distribution systems are used in cold environments, such as high altitude travel of aircraft or in geographic locations near Earth's poles.

Further examples and example combinations thereof are provided by the subject matter of the following clauses:

An apparatus to exhaust hydrogen from a hydrogen distribution system of an engine of an aircraft, the apparatus comprising a vent including a first end coupled to the hydrogen distribution system, and a second end, an exhaust tube coupled to the second end, a temperature sensor disposed adjacent to the exhaust tube, a heater coupled to the exhaust tube, and programmable circuitry to operate the heater based on an output of the temperature sensor.

The apparatus of any preceding clause, wherein the heater receives bleed air from the engine.

The apparatus of any preceding clause, wherein the programmable circuitry is configured to operate the heater based on the output by determining a temperature of hydrogen within the exhaust tube based the output of the temperature sensor, comparing the temperature to a temperature threshold, and operating the heater based on the comparison of the temperature and the temperature threshold.

The apparatus of any preceding clause, wherein the temperature threshold is between 0 and 5 degrees Celsius.

The apparatus of any preceding clause, wherein the heater is a first heater, the exhaust tube is a first exhaust tube, the apparatus further including a second exhaust tube coupled to the second end, and a second heater coupled to the second exhaust tube.

The apparatus of any preceding clause, wherein the temperature sensor is a first temperature sensor, the apparatus further including a second temperature sensor disposed adjacent to the second exhaust tube.

The apparatus of any preceding clause, wherein the output is a first output and the programmable circuitry to operate the second heater based on a second output of the second temperature sensor.

An apparatus to exhaust hydrogen from a hydrogen distribution system of an engine of an aircraft, the apparatus comprising a vent including a first end coupled to the hydrogen distribution system, and a second end, an exhaust tube coupled to the second end, the exhaust tube including an outlet, and a hydrogen concentration sensor positioned in a first position adjacent to the outlet, the hydrogen concentration sensor moveable between the first position and a second position distal to the outlet, and programmable circuitry configured to move the hydrogen concentration sensor from the first position to the second position when fire is present in at least one of the vent or the exhaust tube.

The apparatus of any preceding clause, further comprising a fire detector disposed in at least one of the vent or the exhaust tube, the fire detector to generate an output indicating a presence of fire.

The apparatus of any preceding clause, further comprising a flame arrestor coupled to the outlet.

The apparatus of any preceding clause, further comprising a structural member, wherein the hydrogen concentration sensor is coupled to the structural member, and a motor mechanically coupled to the structural member, wherein the motor is configured to actuate the structural member to move the hydrogen concentration sensor between the first position and the second position.

The apparatus of any preceding clause, wherein the programmable circuitry is further configured to determine if the hydrogen distribution system is venting hydrogen from a hydrogen storage tank, and move the hydrogen concentration sensor from the first position to the second position after determining that the hydrogen distribution system is venting the hydrogen from the hydrogen storage tank.

The apparatus of any preceding clause, wherein the hydrogen storage tank is a cryogenic hydrogen storage tank.

The apparatus of any preceding clause, wherein the programmable circuitry is further configured to determine if the hydrogen distribution system has ceased venting the hydrogen from the hydrogen storage tank, and move the hydrogen concentration sensor from the second position to the first position after determining that the hydrogen distribution system has ceased venting the hydrogen from the hydrogen storage tank.

The apparatus of any preceding clause, wherein the hydrogen concentration sensor is a first hydrogen concentration sensor, the exhaust tube is a first exhaust tube, and the outlet is a first outlet, the apparatus further including a second exhaust tube coupled to the second end, the second exhaust tube including a second outlet, and a second hydrogen concentration sensor positioned in a third position adjacent to the second outlet, the second hydrogen concentration sensor moveable between the third position and a fourth position distal to the second outlet, the programmable circuitry to move the second hydrogen concentration sensor from the third position to the fourth position when fire is present in at least one of the vent or the second exhaust tube.

The apparatus of any preceding clause, wherein the programmable circuitry is further to determine, based on an output of the first hydrogen concentration sensor and the second hydrogen concentration sensor, a loss rate of hydrogen from the hydrogen distribution system.

The apparatus of any preceding clause, wherein the programmable circuitry is further configured to compare the loss rate to a threshold, and generate a service instruction after determining the loss rate satisfies the threshold.

A non-transitory machine readable storage medium comprising instructions to cause programmable circuitry to at least determine that cryogenic hydrogen is being vented via a vent based on an output of a hydrogen distribution system, move, via a control element, a hydrogen concentration sensor from a first position adjacent to an outlet of the vent to a second position distal to the outlet, and move, via the control element, the hydrogen concentration sensor from the second position to the first position after determining that the cryogenic hydrogen has ceased being vented via the vent.

The non-transitory machine readable storage medium of any preceding clause, wherein the instructions cause the programmable circuitry to determine that a fire is present in at least one of the outlet or the vent, and move, via the control element, the hydrogen concentration sensor from the first position to the second position.

The non-transitory machine readable storage medium of any preceding clause, wherein the instructions cause the programmable circuitry to determine, based on a hydrogen concentration output of the hydrogen concentration sensor, a loss rate of hydrogen from the hydrogen distribution system, compare the loss rate to a threshold, and generate a service instruction after determining the loss rate satisfies the threshold.

A method comprising determining a temperature of hydrogen within a vent stack assembly based an output of a temperature sensor of the vent stack assembly, comparing the temperature to a temperature threshold, and activating a heater coupled to the vent stack assembly based after determining the temperature does not satisfy the temperature threshold.

The method of any preceding clause, wherein the temperature threshold is between 0 and 5 degrees Celsius.

The method of any preceding clause, further including deactivating the heater after determining the temperature satisfies the temperature threshold.

A method comprising determining that cryogenic hydrogen is being vented via a vent based on an output of a hydrogen distribution system, moving, via a control element, a hydrogen concentration sensor from a first position adjacent to an outlet of the vent to a second position distal to the outlet, and moving, via the control element, the hydrogen concentration sensor from the second position to the first position after determining that the cryogenic hydrogen has ceased being vented via the vent.

The method of any preceding clause, further including determining that a fire is present in at least one of the outlet or the vent, and moving, via the control element, the hydrogen concentration sensor from the first position to the second position.

A method comprising determining, based on an output of a hydrogen concentration sensor of a vent stack assembly, a loss rate of hydrogen from a hydrogen distribution system coupled to the vent stack assembly, comparing the loss rate to a threshold, and generating a service instruction after determining the loss rate satisfies the threshold.

The method of any preceding clause, further including determining the hydrogen concentration sensor is positioned adjacent to an exhaust tube of the vent stack assembly.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to exhaust hydrogen from a hydrogen distribution system of an engine of an aircraft, the apparatus comprising:
a vent including:
a first end coupled to the hydrogen distribution system; and
a second end;
an exhaust tube coupled to the second end;
a temperature sensor disposed adjacent to the exhaust tube;
a heater coupled to the exhaust tube; and
programmable circuitry to operate the heater based on an output of the temperature sensor.

2. The apparatus of claim 1, wherein the heater receives bleed air from the engine.

3. The apparatus of claim 1, wherein the programmable circuitry is configured to operate the heater based on the output by:
determining a temperature of hydrogen within the exhaust tube based on the output of the temperature sensor;
comparing the temperature to a temperature threshold; and
operating the heater based on the comparison of the temperature and the temperature threshold.

4. The apparatus of claim 3, wherein the temperature threshold is between 0 and 5 degrees Celsius.

5. The apparatus of claim 1, wherein the heater is a first heater, the exhaust tube is a first exhaust tube, the apparatus further including:
a second exhaust tube coupled to the second end; and
a second heater coupled to the second exhaust tube.

6. The apparatus of claim 5, wherein the temperature sensor is a first temperature sensor, the apparatus further including a second temperature sensor disposed adjacent to the second exhaust tube.

7. The apparatus of claim 6, wherein the output is a first output and the programmable circuitry to operate the second heater is based on a second output of the second temperature sensor.

8. An apparatus to exhaust hydrogen from a hydrogen distribution system of an engine of an aircraft, the apparatus comprising:
a vent including:
a first end coupled to the hydrogen distribution system; and
a second end;
an exhaust tube coupled to the second end, the exhaust tube including an outlet; and
a hydrogen concentration sensor positioned in a first position adjacent to the outlet, the hydrogen concentration sensor moveable between the first position and a second position distal to the outlet; and
programmable circuitry configured to move the hydrogen concentration sensor from the first position to the second position when fire is present in at least one of the vent or the exhaust tube.

9. The apparatus of claim 8, further comprising a fire detector disposed in at least one of the vent or the exhaust tube, the fire detector to generate an output indicating a presence of fire.

10. The apparatus of claim 8, further comprising a flame arrestor coupled to the outlet.

11. The apparatus of claim 8, further comprising:
a structural member, wherein the hydrogen concentration sensor is coupled to the structural member; and
a motor mechanically coupled to the structural member, wherein the motor is configured to actuate the structural member to move the hydrogen concentration sensor between the first position and the second position.

12. The apparatus of claim 8, wherein the programmable circuitry is further configured to:
determine if the hydrogen distribution system is venting hydrogen from a hydrogen storage tank; and
move the hydrogen concentration sensor from the first position to the second position after determining that the hydrogen distribution system is venting the hydrogen from the hydrogen storage tank.

13. The apparatus of claim 12, wherein the hydrogen storage tank is a cryogenic hydrogen storage tank.

14. The apparatus of claim 12, wherein the programmable circuitry is further configured to:
determine if the hydrogen distribution system has ceased venting the hydrogen from the hydrogen storage tank; and
move the hydrogen concentration sensor from the second position to the first position after determining that the hydrogen distribution system has ceased venting the hydrogen from the hydrogen storage tank.

15. The apparatus of claim 8, wherein the hydrogen concentration sensor is a first hydrogen concentration sensor, the exhaust tube is a first exhaust tube, and the outlet is a first outlet, the apparatus further including:
a second exhaust tube coupled to the second end, the second exhaust tube including a second outlet; and
a second hydrogen concentration sensor positioned in a third position adjacent to the second outlet, the second hydrogen concentration sensor moveable between the third position and a fourth position distal to the second outlet, the programmable circuitry to move the second hydrogen concentration sensor from the third position to the fourth position when fire is present in at least one of the vent or the second exhaust tube.

16. The apparatus of claim 15, wherein the programmable circuitry is further to determine, based on an output of the first hydrogen concentration sensor and the second hydrogen concentration sensor, a loss rate of hydrogen from the hydrogen distribution system.

17. The apparatus of claim 16, wherein the programmable circuitry is further configured to:
compare the loss rate to a threshold; and
generate a service instruction after determining the loss rate satisfies the threshold.

18. A non-transitory machine readable storage medium comprising instructions to cause programmable circuitry to at least:
determine that cryogenic hydrogen is being vented via a vent based on an output of a hydrogen distribution system;
move, via a control element, a hydrogen concentration sensor from a first position adjacent to an outlet of the vent to a second position distal to the outlet; and
move, via the control element, the hydrogen concentration sensor from the second position to the first position after determining that the cryogenic hydrogen has ceased being vented via the vent.

19. The non-transitory machine readable storage medium of claim 18, wherein the instructions cause the programmable circuitry to:
determine that a fire is present in at least one of the outlet or the vent; and
move, via the control element, the hydrogen concentration sensor from the first position to the second position.

20. The non-transitory machine readable storage medium of claim 18, wherein the instructions cause the programmable circuitry to:
determine, based on a hydrogen concentration output of the hydrogen concentration sensor, a loss rate of hydrogen from the hydrogen distribution system;
compare the loss rate to a threshold; and
generate a service instruction after determining the loss rate satisfies the threshold.
